(19) United States
(12) Patent Application Publication
(10) Pub. No.: US 2026/0352735 A1
(43) Pub. Date: Nov. 5, 2026

(54) COMMUNICATION METHOD AND APPARATUS, MEDIUM, COMMUNICATION DEVICE, AND COMMUNICATION SYSTEM

(71) Applicant: Beijing Xiaomi Mobile Software Co., Ltd., Beijing (CN)

(72) Inventors: Chunhui ZHU, Beijing (CN); Yang SHEN, Beijing (CN)

(73) Assignee: Beijing Xiaomi Mobile Software Co., Ltd., Beijing (CN)

(21) Appl. No.: 19/488,266

(22) PCT Filed: May 30, 2023
(86) PCT No.: PCT/CN2023/097272

§ 371 Date: Nov. 26, 2025

(51) Int. Cl. H04L 67/125; H04L 41/0806; H04L 41/0894; H04W 4/50; H04W 48/18

(52) U.S. Cl. CPC H04L 67/125; H04L 41/0806; H04L 41/0894; H04W 4/50; H04W 48/18

(57) ABSTRACT

A communication method, including: sending first information, where the first information is configured for an Internet of Things (IoT) terminal to permanently deactivate a network service.

### CROSS-REFERENCE TO RELATED APPLICATIONS

The present application is a U.S. National Stage of International Application No. PCT/CN2023/097272, filed on May 30, 2023, the contents of all of which are incorporated herein by reference in their entirety for all purposes.

### BACKGROUND OF THE INVENTION

Internet of Things (IoT) services are involved in the 3rd generation partnership project (3GPP) standards. In IoT services, it is necessary to manage IoT terminals.

### SUMMARY OF THE INVENTION

The present disclosure relates to the field of communication technology, and in particular, to a communication method, a medium, and a communication device.

The present disclosure provides a communication method, a storage medium, and a communication device.

According to a first aspect of embodiments of the present disclosure, a communication method is provided, and is performed by a policy control function network element. The communication method includes:
sending first information, where the first information is configured for an Internet of Things (IoT) terminal to permanently deactivate a network service.

According to a second aspect of the embodiments of the present disclosure, a communication method is provided, and is performed by an IoT terminal. The communication method includes:
receiving first information from a policy control function network element; and
permanently deactivating a network service according to the first information.

According to a third aspect of the embodiments of the present disclosure, a communication method is provided, and is performed by an access and mobility management function network element. The method includes:
sending first information to an IoT terminal, where the first information is configured for the IoT terminal to permanently deactivate a network service.

According to a fourth aspect of the embodiments of the present disclosure, a communication device is provided. The communication device includes: one or more processors; and a memory that stores computer-executable instructions; where the computer-executable instructions, when collectively executed by the one or more processors, cause the communication device to perform the communication method provided in the second aspect of the present disclosure.

According to a fifth aspect of the embodiments of the present disclosure, a non-transitory computer-readable storage medium storing computer-executable instructions is provided, where the computer-executable instructions, when executed by a communication device, cause the communication device to perform the communication method provided in the second aspect of the present disclosure.

It is to be understood that the above general description and the following detailed description are merely illustrative and explanatory and do not limit the present disclosure.

### BRIEF DESCRIPTION OF DRAWINGS

In order to more clearly illustrate the technical solutions in the embodiments of the present disclosure, the accompanying drawings needed for the description of the embodiments are described below. The following accompanying drawings show merely some embodiments of the present disclosure and do not impose specific limitations on the protection scope of the present disclosure.

FIG. 1a is a schematic diagram of a communication system according to some embodiments.

FIG. 2a is a flowchart of a communication method according to some embodiments.

FIG. 2b is a flowchart of a communication method according to some embodiments.

FIG. 2c is a flowchart of a communication method according to some embodiments.

FIG. 2d is a flowchart of a communication method according to some embodiments.

FIG. 2e is a flowchart of a communication method according to some embodiments.

FIG. 2f is a flowchart of a communication method according to some embodiments.

FIG. 2g is a flowchart of a communication method according to some embodiments.

FIG. 3a is a flowchart of a communication method according to some embodiments.

FIG. 3b is a flowchart of a communication method according to some embodiments.

FIG. 3c is a flowchart of a communication method according to some embodiments.

FIG. 3d is a flowchart of a communication method according to some embodiments.

FIG. 4a is a flowchart of a communication method according to some embodiments.

FIG. 4b is a flowchart of a communication method according to some embodiments.

FIG. 4c is a flowchart of a communication method according to some embodiments.

FIG. 5a is a flowchart of a communication method according to some embodiments.

FIG. 5b is a flowchart of a communication method according to some embodiments.

FIG. 5c is a flowchart of a communication method according to some embodiments.

FIG. 6 is a flowchart of a communication method according to some embodiments.

FIG. 7a is a flowchart of a communication method according to some embodiments.

FIG. 7b is a flowchart of a communication method according to some embodiments.

FIG. 7c is a flowchart of a communication method according to some embodiments.

FIG. 8a is a block diagram of a communication apparatus according to some embodiments.

FIG. 8b is a block diagram of a communication apparatus according to some embodiments.

FIG. 8c is a block diagram of a communication apparatus according to some embodiments.

FIG. 8d is a block diagram of a communication apparatus according to some embodiments.

FIG. 8e is a block diagram of a communication apparatus according to some embodiments.

FIG. 9 is a block diagram of a terminal according to some embodiments.

FIG. 10 is a block diagram of a network device according to some embodiments.

### DETAILED DESCRIPTION OF THE INVENTION

The embodiments of the present disclosure are not exhaustive and are merely illustrative of some embodiments, without imposing specific limitations on the scope of protection of the present disclosure. Each step in a certain embodiment may be implemented as an independent embodiment, and various steps may be combined in any order without conflict. For example, a solution in which some steps are removed from a certain embodiment may also be implemented as an independent embodiment, and the order of various steps in a certain embodiment may be exchanged arbitrarily. Additionally, optional implementations in a certain embodiment may be combined in any way. Furthermore, various embodiments may be combined in any way. For example, some or all steps of different embodiments may be combined in any way, or a certain embodiment may be combined with optional implementations from other embodiments in any way.

In various embodiments of the present disclosure, the terms and/or descriptions across various embodiments are consistent and may be referenced interchangeably, in the case of no special explanation and logic conflict. The technical features in different embodiments may be combined according to their inherent logical relationships to form new embodiments.

The terms used in the embodiments of the present disclosure are merely for the purpose of describing specific embodiments and are not intended to limit the present disclosure.

In the embodiments of the present disclosure, unless otherwise specified, elements expressed in singular form, such as “one,” “a/an,” “this,” “above-mentioned,” “the,” “aforementioned,” and “such,” may mean “one and just one”, “one or more,” or “at least one”. For example, in a case where articles such as “a,” “an,” and “the” are used in translation, the noun following the article may be understood as either singular or plural.

In the embodiments of the present disclosure, “a plurality of” means two or more.

In some embodiments, terms such as “at least one of,” “one or more,” “a plurality of,” and “multiple” may be used interchangeably.

In some embodiments, phrases such as “at least one of A or B,” “A and/or B,” “A in a case, and B in another case,” and “A in response to a case, and B in response to another case” may include the following technical solutions: in some embodiments, A (A is performed independently of B); in some embodiments, B (B is performed independently of A); in some embodiments, A and B are selectively performed (A and B are performed selectively); in some embodiments, both A and B are performed (A and B both are performed), depending on circumstances. Similar logic applies in cases where more branches, such as A, B, and C, are involved.

In some embodiments, phrases such as “A or B” may include the following technical solutions: in some embodiments, A (A is performed independently of B); in some embodiments, B (B is performed independently of A); in some embodiments, A and B are selectively performed (A and B are performed selectively), depending on circumstances. Similar logic applies in cases where more branches, such as A, B, and C, are involved.

Prefixes such as “first” and “second” in the embodiments of the present disclosure are merely to distinguish different described objects and do not impose limitations on the positions, order, priorities, quantities, content, etc. of the described objects. For the description of the described objects, reference is made to the description of the claims or the context in the embodiments, and it is not supposed to impose redundant limitations due to the use of prefixes. For example, the ordinal numbers before “field” in “first field” and “second field” do not limit the positions or order of the fields, nor do they limit whether the “first field” and “second field” are in the same message or their sequence, in a case where the described object is “field”. For another example, the ordinal numbers before “level” in “first level” and “second level” do not limit the priorities of the levels, in a case where the described object is “level”. For another example, the quantity of the described object is not limited by the ordinal numbers and may be one or more. Taking “first apparatus” as an example, the count of “apparatuses” may be one or more. Furthermore, objects modified by different prefixes may be the same or different. For example, “first apparatus” and “second apparatus” may be the same apparatus or different apparatuses, and their types may be the same or different, in a case where the described object is “apparatus”. For another example, “first information” and “second information” may be the same information or different information, and their content may be the same or different, in a case where the described object is “information”.

In some embodiments, “including A,” “comprising A,” “for indicating A,” and “carrying A” may be interpreted as directly carrying A or may be interpreted as indirectly indicating A. In some embodiments, terms such as “in response to . . . ,” “in response to determining . . . ,” “in a case where . . . ,” “upon . . . ,” “when . . . ,” “in a case of . . . ” and “providing . . . ” may be used interchangeably.

In some embodiments, terms such as “greater than,” “greater than or equal to,” “not less than,” “more than,” “more than or equal to,” “not fewer than,” “higher than,” “higher than or equal to,” “not lower than,” and “above” may be used interchangeably, and terms such as “less than,” “less than or equal to,” “not greater than,” “fewer than,” “fewer than or equal to,” “not more than,” “lower than,” “lower than or equal to,” “not higher than” and “below” may be used interchangeably.

In some embodiments, an apparatus may be interpreted as physical or may be interpreted as virtual, and its name is not limited to those described in the embodiments. Terms such as “apparatus,” “equipment,” “device,” “circuit,” “network element,” “node,” “function,” “unit,” “section,” “system,” “network,” “chip,” “chip system,” “entity,” and “body” may be used interchangeably.

In some embodiments, terms such as “access network device (AN device),” “radio access network device (RAN device),” “base station (BS),” “radio base station,” “fixed station,” “node,” “access point,” “transmission point (TP),” “reception point (RP),” “transmission/reception point (TRP),” “panel,” “antenna panel,” “antenna array,” “cell,” “macro cell,” “small cell,” “femto cell,” “pico cell,” “sector,” “cell group,” “carrier,” “component carrier,” and “bandwidth part (BWP)” may be used interchangeably.

In some embodiments, terms such as “terminal,” “terminal device,” “user equipment (UE),” “user terminal,” “mobile station (MS),” “mobile terminal (MT),” “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” and “client” may be used interchangeably.

In some embodiments, an access network device, a core network device, or a network device may be replaced with a terminal. For example, the embodiments of the present disclosure may also be applied to a structure where the communication between the access network device, the core network device, or the network device and the terminal is replaced with communication between a plurality of terminals (for example, it may also be referred to as device-to-device (D2D), vehicle-to-everything (V2X), etc.). In this case, the terminal may be configured to have all or part of the functions of the access network device. Additionally, terms such as “uplink” and “downlink” may also be replaced with terms corresponding to inter-terminal communication (e.g., “side”). For example, an uplink channel or a downlink channel may be replaced with a sidelink channel, and uplink or downlink may be replaced with sidelink.

In some embodiments, a terminal may be replaced with an access network device, a core network device, or a network device. In this case, the access network device, the core network device, or the network device may also be configured to have a structure that includes all or part of the functions of the terminal.

In some embodiments, the names of information and others are not limited to those described in the embodiments. Terms such as “information,” “message,” “signal,” “signaling,” “report,” “configuration,” “indication,” “instruction,” “command,” “channel,” “parameter,” “domain,” “field,” “symbol,” “codebook,” “codeword,” “codepoint,” “bit,” “data,” “program,” and “chip” may be used interchangeably.

In some embodiments, terms such as “uplink,” and “physical uplink” may be used interchangeably, terms such as “downlink,” and “physical downlink” may be used interchangeably, terms such as “side,” “sidelink,” and “sidelink communication” may be used interchangeably, and terms such as “direct connection,” “direct link,” “direct communication,” and “direct link communication” may be used interchangeably.

In some embodiments, terms such as “downlink control information (DCI),” “downlink (DL) assignment,” “DL DCI,” “uplink (UL) grant,” and “UL DCI” may be used interchangeably.

In some embodiments, terms such as “physical downlink shared channel (PDSCH)” and “DL data” may be used interchangeably, and terms such as “physical uplink shared channel (PUSCH)” and “UL data” may be used interchangeably.

In some embodiments, terms such as “radio,” “wireless,” “radio access network (RAN),” “access network (AN),” and “RAN-based” may be used interchangeably.

In some embodiments, terms such as “search space,” “search space set,” “search space configuration,” “search space set configuration,” “control resource set (CORESET),” and “CORESET configuration” may be used interchangeably.

In some embodiments, terms such as “synchronization signal (SS),” “synchronization signal block (SSB),” “reference signal (RS),” “pilot,” and “pilot signal” may be used interchangeably.

In some embodiments, terms such as “moment,” “time point,” “time,” and “time position” may be used interchangeably, and terms such as “duration,” “time period,” “time window,” “window,” and “time” may be used interchangeably.

In some embodiments, terms such as “component carrier (CC),” “cell,” “frequency carrier,” and “carrier frequency” may be used interchangeably.

In some embodiments, terms such as “resource block (RB),” “physical resource block (PRB),” “sub-carrier group (SCG),” “resource element group (REG),” “PRB pair,” “RB pair,” and “resource element (RE)” may be used interchangeably.

In some embodiments, terms such as “wireless access scheme” and “waveform” may be used interchangeably.

In some embodiments, terms such as “frame,” “radio frame,” “subframe,” “slot,” “sub-slot,” “mini-slot,” “symbol,” and “transmission time interval (TTI)” may be used interchangeably.

In some embodiments, “acquire,” “obtain,” “get,” “receive,” “transmit,” “bidirectional transmission,” and “send and/or receive” may be used interchangeably. These may be interpreted as receiving from other entities, obtaining via a protocol, or obtaining via self-processing or self-implementation, etc.

In some embodiments, terms such as “send,” “transmit,” “report,” “deliver,” “transfer,” “bidirectional transmission,” and “send and/or receive” may be used interchangeably.

In some embodiments, “predetermined” and “preset” may be interpreted as pre-specified in a protocol or may be interpreted as a pre-set action performed by an apparatus.

In some embodiments, determination or judgment may be performed by a value represented by 1 bit (0 or 1), may be performed by a true/false value (boolean value (boolean)) represented as true or false, or may further be performed by numerical comparison (e.g., comparison with a predetermined value), but is not limited to these.

In some embodiments, “network” may be interpreted as an apparatus (e.g., an access network device, a core network device, or a network device) included within a network.

In some embodiments, “not expected to receive” may be interpreted as not receiving on at least one of a time-domain resource or a frequency-domain resource, or may be interpreted as not performing, after data is received, subsequent processing on the received data, and “not expected to send” may be interpreted as not sending, or may be interpreted as sending without expecting a response from a receiver to sending content.

In some embodiments, data, information, etc., may be obtained in accordance with the laws and regulations of the local country.

In some embodiments, data, information, etc., may be obtained after obtaining the consent of a user.

Furthermore, each element, each row, or each column in tables of the embodiments of the present disclosure may be implemented as an independent embodiment, and a combination of any elements, any rows, or any columns may be implemented as an independent embodiment.

Although operations are described in a specific order in the figures in the embodiments of the present disclosure, it is not to be understood as demanding that these operations are performed in a specific order shown or in a serial order, or that all the operations shown are performed to obtain a desired result. In a specific environment, multitasking and parallel processing may be beneficial. Additionally, sending a plurality of pieces of information via the same message may also be beneficial.

The following describes an application environment of a communication method provided by the embodiments.

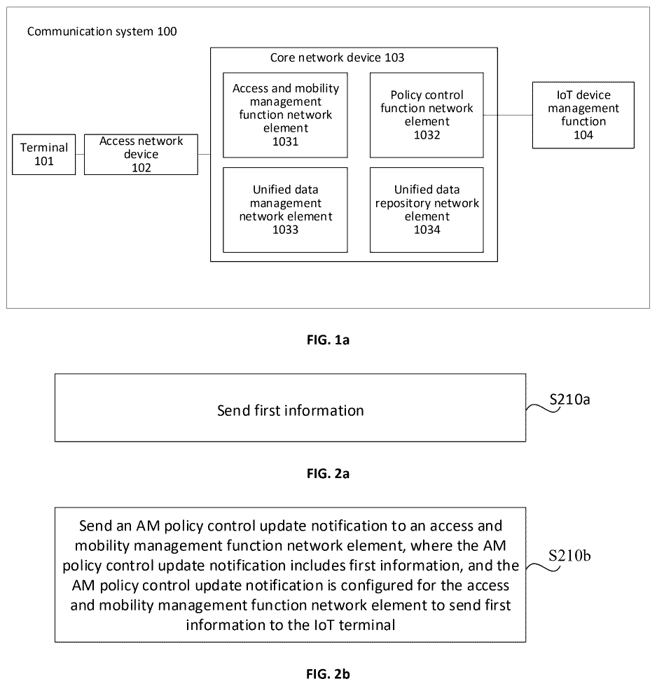

FIG. 1a is a schematic diagram of an architecture of a communication system 100 according to an embodiment of the present disclosure.

As shown in FIG. 1a, the communication system 100 includes a terminal 101, an access network device 102, and a core network device 103.

In some embodiments, the terminal 101 may be an Internet of Things (IoT) terminal.

In some embodiments, the IoT terminal may be, for example, an ambient power-enabled Internet of Things (A-IoT) terminal. The ambient power-enabled IoT is an IoT service, and the IoT terminal is powered by an energy harvesting apparatus or an activator. The energy harvesting apparatus or the activator is not shown in FIG. 1a, and it is battery-less or with a limited energy storage capability (i.e., using a capacitor). The energy harvesting apparatus or the activator may enable communication with the IoT terminal without a conventional power source, and/or avoid human intervention for recharging or replacing. The ambient power-enabled IoT terminal does not have a conventional battery and obtains energy via an ambient IoT operation. The ambient IoT operation may be understood as utilizing energy from wireless radio waves or other sources, where such energy is obtained in particular use cases. For example, in some cases, the ambient power-enabled IoT terminal may obtain energy from a radio wave, which may come from an access network entity or other terminals. In some other scenarios, the ambient power-enabled IoT terminal obtains energy from solar, light, motion/vibration, heat, pressure, or any other energy sources. An Internet of Things terminal supporting ambient power enabling does not need a conventional battery, and therefore is friendly to the environment. The ambient power-enabled IoT terminal may also be referred to as zero-power IoT, and the name is not limited here.

In some implementations, any IoT terminal that can support ambient power enabling may be referred to as an ambient power-enabled IoT terminal, regardless of whether it can solely support ambient power enabling.

In some embodiments, the access network device 102 is, for example, a node or device that connects a terminal to a wireless network, such as a radio access network (RAN). The access network device 102 may include at least one of the following: an evolved NodeB (eNB) in a 5G communication system, a next-generation eNB (NG-eNB), a next generation NodeB (gNB), a nodeB (NB), a home node B (HNB), a home evolved nodeB (HeNB), a wireless backhaul device, a radio network controller (RNC), a base station controller (BSC), a base transceiver station (BTS), a base band unit (BBU), a mobile switching center, a base station in a 6G communication system, an open RAN, a cloud RAN, a base station in other communication systems, or an access node in a wireless fidelity (Wi-Fi) system, but is not limited to these.

In some embodiments, the technical solutions of the present disclosure may be applied to an open RAN architecture. In this case, interfaces between or within access network devices involved in the embodiments of the present disclosure may become internal interfaces of the open RAN, and processes and information exchanges between these internal interfaces may be implemented via software or a program.

In some embodiments, the access network device 102 may be composed of a central unit (CU) and a distributed unit (DU), and the CU is also referred to as a control unit. Adopting the CU-DU structure can split the protocol layers of the access network device. The functions of some protocol layers are placed in the CU for centralized control, and the functions of some or all of the remaining protocol layers are distributed in the DU. The CU centrally controls the DU, but is not limited thereto.

In some embodiments, the core network device 103 may be a single device, including one or more network elements. For example, the core network device 103 may include an access and mobility management function (AMF) network element 1031, a policy control function (PCF) network element 1032, a unified data management (UDM) network element 1033, a unified data repository (UDR) network element 1034, and so on. The core network device 103 may also be a plurality of devices or device groups, each including all or part of the access and mobility management function network element 1031, the policy control function network element 1032, the unified data management network element 1033, the unified data repository network element 1034, and so on. A network element may be virtual or physical. The core network, for example, includes at least one of an evolved packet core (EPC), a 5G core network (5GCN), or a next-generation core (NGC).

In some implementations, the access and mobility management function network element 1031 is configured to achieve access and mobility management of a terminal in a mobile network, and its name is not limited thereto.

In some implementations, the policy control function network element 1032 is configured to achieve the management of a user control policy, and its name is not limited thereto.

In some implementations, the unified data management network element 1033 is configured to achieve the management of subscription data, roaming control, etc., for the user, and its name is not limited thereto.

In some implementations, the unified data repository network element 1034 is configured to store subscription data and policy data of the UDM and the PCF, and its name is not limited thereto.

In some implementations, the communication system 100 may further include an IoT device management function (IDMF).

In some implementations, the IoT device management function may be a new application function (AF), and it may be referred to as, for example, an IoT device management function AF. This new AF may be independent of the core network device or may be part of the core network device.

In some implementations, continuing to refer to FIG. 1a, the communication system 100 may further include an AF that is independent of the core network device 103, i.e., the AF that is the IoT device management function 104.

In some implementations, the IoT device management function may also be a new function in an existing AF; for example, the IoT device management function may be a newly extended function in an existing IoT application function (IoT AF).

In some implementations, the IoT device management function may also be a new network element; for example, it may be referred to as an IoT device management function network element. This new network element may be independent of the core network device 103 or may be part of the core network device 103.

In some implementations, the IoT device management function may also be a new function in an existing network element; for example, the IoT device management function may be a newly extended function in an existing policy control function network element.

In some implementations, the name of the IoT device management function is not limited; for example, it may be referred to as an IoT terminal management function, an invoker, etc.

It can be understood that the communication system 100 described in the embodiments of the present disclosure is for more clearly illustrating the technical solutions of the embodiments of the present disclosure and does not constitute a limitation on the technical solutions provided by the embodiments of the present disclosure. Those of ordinary skill in the art can understand that, with the evolution of system architectures and the emergence of new service scenarios, the technical solutions provided by the embodiments of the present disclosure are also applicable to similar technical problems.

The following embodiments of the present disclosure may be applied to the communication system 100 or some entities shown in FIG. 1a, but are not limited to these. Various entities shown in FIG. 1a are illustrative, and the communication system 100 may include all or part of the entities in FIG. 1a, or may also include other entities not shown in FIG. 1a. The count and form of the entities are arbitrary, and the connection relationships between the entities are illustrative. The entities may or may not be connected, and their connections may be in any form. The connections may be direct or indirect connections, or wired or wireless connections.

Various embodiments of the present disclosure may be applied to long term evolution (LTE), LTE-Advanced (LTE-A), LTE-Beyond (LTE-B), SUPER 3G, IMT-Advanced, 4th generation mobile communication system (4G), 5th generation mobile communication system (5G), 5G New Radio (NR), future radio access (FRA), a new radio access technology (RAT), new radio (NR), new radio access (NX), future generation radio access (FX), global system for mobile communications (GSM (registered trademark)), CDMA 2000, ultra mobile broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), public land mobile network (PLMN), device-to-device (D2D) system, machine-to-machine (M2M) system, IoT system, vehicle-to-everything (V2X), systems using other communication methods, next-generation systems extended based on these, etc. Additionally, a plurality of systems may be combined (e.g., a combination of LTE or LTE-A and 5G) for application.

The following describes some implementations of the present disclosure.

In some implementations of the present disclosure, a UE may send a radio resource control (RRC) establishment request, which includes a registration request, to a next-generation radio access network (NG-RAN). The registration request includes a registration type, a subscription concealed identifier (SUCI) or a 5G globally unique temporary UE identity (5G-GUTI) or a paging early indication (PEI), and a security parameter. The NG-RAN initiates an N2 setup, for example, an initial UE message to the AMF. The registration request may be included in a request from the NG-RAN to the AMF.

In some implementations of the present disclosure, a new AMF performs access management (AM) policy association establishment/modification. In a case where the new AMF selects a new PCF, the new AMF performs AM policy association establishment with the selected PCF.

In some implementations of the present disclosure, in a case where a PCF identified by a PCF ID included in the UE context from an old AMF is used, the new AMF performs AM policy association modification with this PCF.

In some implementations of the present disclosure, the PCF shall provide updated mobility restrictions to the AMF, in a case where the AMF notifies the PCF of mobility restrictions, such as a UE location, for adjustment, or in a case where the PCF updates the mobility restrictions itself due to some conditions, such as application in use, time, and date. The AMF provides a tracking requirement to the PCF in a case where subscription information includes the tracking requirement.

In some embodiments of the present disclosure, the AMF receives an N2 setup request and a registration request. After authentication and authorization of the UE, the AMF sends a registration accept to the UE via the NG-RAN.

In some embodiments of the present disclosure, based on an operator policy, a network system (e.g., a 5G system) may provide means for a trusted third party to request the permanent disabling of a terminal from communicating with the network system. The terminal here may be an IoT terminal or a non-IoT terminal.

In some implementations of the present disclosure, in a case where the terminal is the ambient power-enabled IoT terminal, the ambient power-enabled IoT terminal is expected to harvest energy and, at the same time, use the harvested energy to support communication. Although the ambient power-enabled IoT terminal has constraints such as complexity, size, and power consumption, it has the capability to provide a sufficient communication service to meet a corresponding requirement.

In some implementations of the present disclosure, in a case where the subscription of the ambient power-enabled IoT terminal is suspended or terminated, or the ambient power-enabled IoT terminal is discarded, the ambient power-enabled IoT terminal can still continuously harvest energy and may continue to attempt to access the network or be accessed by the network. This may result in a security risk where the ambient power-enabled IoT terminal may be obtained by an unauthorized user. In this way, data or other parameters of the ambient power-enabled IoT terminal may be obtained by the unauthorized user, such that the data or the other parameters of the ambient power-enabled IoT terminal may be subject to unauthorized access.

In some implementations of the present disclosure, based on an operator policy, a network system (e.g., the 5G system) may provide means for a trusted third party to request the permanent disabling of the ambient power-enabled IoT terminal from communicating with the network system.

Hence, in some implementations of the present disclosure, it is needed to manage the IoT terminal, such as the ambient power-enabled IoT terminal.

In some embodiments, managing the IoT terminal may involve allowing the IoT terminal to permanently deactivate a network service, such that the network service may never be activated or accessed again.

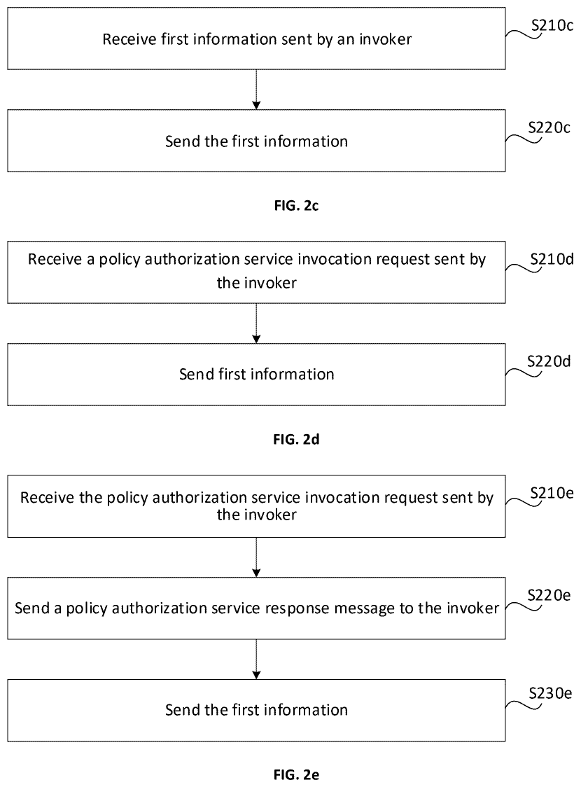

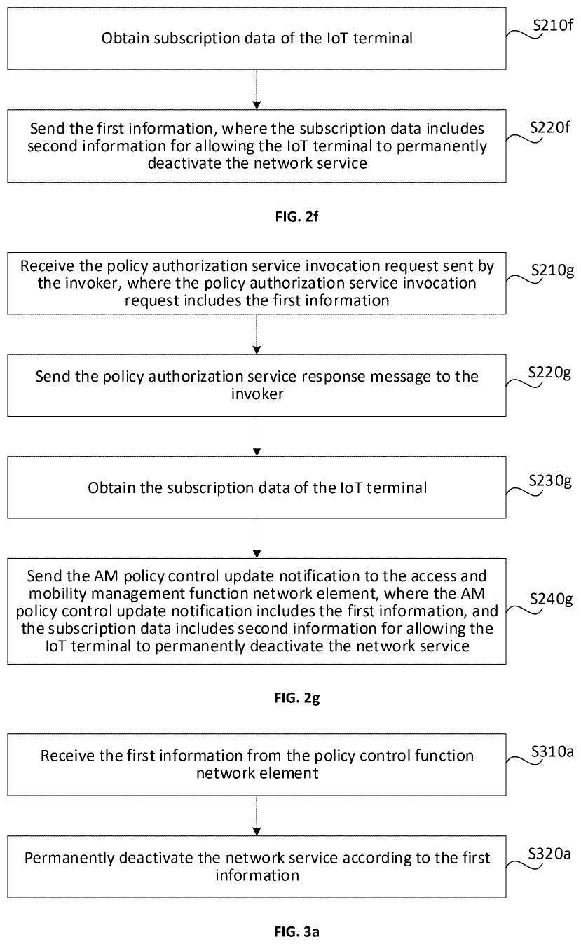

FIG. 2a is a flowchart of a communication method according to some embodiments. As shown in FIG. 2a, the communication method may be performed by a policy control function network element, and the communication method includes step S210a.

In step S210a, first information is sent.

In some implementations, the first information is configured for an IoT terminal to permanently deactivate a network service.

In some implementations, the IoT terminal may be an ambient power-enabled IoT terminal.

In some implementations, the ambient power-enabled IoT terminal supports an ambient IoT operation.

In some implementations, the IoT terminal may receive the first information and permanently deactivate the network service according to the first information.

In some implementations, the name of the first information is not limited; for example, the first information may also be referred to as deactivating indication information, permanent deactivating indication information, first indication information, or simply as indication information.

In some implementations, the first information may be generated by a newly extended function in the policy control function network element or by another network element or AF distinct from the policy control function network element. For example, the first information may be generated by the new IoT device management function AF mentioned in the foregoing embodiments, the newly extended function in the IoT AF, or an IoT device management function network element.

In some implementations, the first information may be generated and sent by an invoker. The invoker may include at least one of the following:
an extended function of the IoT application function, a new first application function, a new first network element, or an extended function of the policy control function network element.

In some implementations, the invoker may be the IoT device management function mentioned in the foregoing embodiments.

In some implementations, the IoT device management function may be an extended function of the IoT application function, a new first application function, a new first network element, or an extended function of the policy control function network element, where the first network element has an IoT device management function.

In some implementations, in a case where the first information is generated by the policy control function network element, a module for generating the first information may be extended within the policy control function network element; for example, this module may be referred to as an IoT device management function module. In this way, the first information is generated via the IoT device management function module.

In some implementations, the generated first information is associated with an identifier of the IoT terminal, so that the corresponding IoT terminal may be determined based on the identifier of the IoT terminal. In this way, the corresponding IoT terminal is enabled to permanently deactivate a network service according to the first information.

The embodiments of the present application stipulate that the policy control function network element can send the first information configured for the IoT terminal to permanently deactivate the network service, so that the IoT terminal can permanently deactivate the network service of the IoT terminal, and the management of the IoT terminal can be achieved. In this way, the data of the IoT terminal can be prevented from being obtained by an unauthorized user, and the data security of the IoT terminal is protected. A new indication from the policy control function network element to the IoT terminal is provided in the embodiments of the present application.

In some implementations, the first information may also be configured for a terminal to permanently deactivate a network service.

In some implementations, the terminal may be, for example, a smartphone, a smart wearable device, a smart speaker, a smart tablet, a wireless modem, a wireless local loop (WLL) station, a personal digital assistant (PDA), or customer premise equipment (CPE). With the development of wireless communication technology, any device that can access the communication system, communicate with the access network device in the communication system, or communicate with another object via the communication system may be the terminal in the embodiments of the present disclosure, such as a terminal and a vehicle in intelligent transportation, a home device in smart home, an electricity metering instrument in smart grid, a voltage monitoring instrument and an environmental monitoring instrument, a video monitoring instrument in smart security network, a cash register, an IoT terminal, and an ambient power-enabled IoT terminal.

The embodiments of the present application stipulate that the policy control function network element may send first information configured for the terminal to permanently deactivate the network service, thereby enabling the terminal to permanently deactivate the network service, and achieving the management of the terminal. In this way, the data of the terminal can be prevented from being obtained by an unauthorized user, and the data security of the terminal is protected. A new indication from the policy control function network element to the terminal is provided in the embodiments of the present application.

FIG. 2b is a flowchart of a communication method according to some embodiments. As shown in FIG. 2b, the communication method may be performed by a policy control function network element, and the communication method includes step S210b.

In step S210b, an AM policy control update notification is sent to an access and mobility management function network element, where the AM policy control update notification includes first information, and the AM policy control update notification is configured for the access and mobility management function network element to send the first information to the IoT terminal.

In some implementations, the first information is configured for the IoT terminal to permanently deactivate the network service.

In some implementations, the policy control function network element may carry the first information in the AM policy control update notification, thereby sending the first information to the access and mobility management function network element via the AM policy control update notification.

In some implementations, after receiving the AM policy control update notification sent by the policy control function network element, the access and mobility management function network element may send the first information carried in the AM policy control update notification to the IoT terminal.

In some implementations, the access and mobility management function network element may send a non-access stratum (NAS) notification to the IoT terminal, where the NAS notification includes the first information. That is, the access and mobility management function network element may send the first information to the IoT terminal via the NAS notification.

In some implementations, the name of the AM policy control update notification is not limited; for example, Npcf_AMPolicyControl_UpdateNotify or the first notification.

In some implementations, the AM policy control update notification may further include an AM policy association ID associated with a subscription permanent identifier (SUPI). The policy update may include information such as service area restrictions, UE aggregated maximum bit rate (UE-AMBR), a RAT/frequency selection priority (RFSP) index value, an access stratum time distribution indication, and a time synchronization error budget.

For the detailed description of step S210b, reference may be made to the foregoing embodiments, and details are not described here.

The embodiments of the present application stipulate that the policy control function network element may send the first information to the access and mobility management function network element via the AM policy control update notification, so that the access and mobility management function network element may send the first information to the terminal according to the AM policy control update notification.

FIG. 2c is a flowchart of a communication method according to some embodiments. As shown in FIG. 2c, the communication method may be performed by the policy control function network element, and the communication method includes steps: S210c and S220c.

In step S210c, the first information sent by an invoker is received.

In step S220c, the first information is sent.

In some implementations, the first information is configured for the IoT terminal to permanently deactivate the network service.

In some implementations, the first information may be generated and sent to the policy control function network element by the invoker.

In some embodiments, the invoker includes at least one of the following:
an extended function of the IoT application function, the new first application function, the new first network element, or the extended function of the policy control function network element.

In some implementations, the invoker may generate the first information and send the first information to the policy control function network element. The policy control function network element may send the first information after receiving the first information.

In some implementations, in a case where the invoker is a newly extended functional module within the policy control function network element, such as an extended IoT device management function module, a functional module that is within the policy control function network element and is configured to send the first information may receive the first information sent by the newly extended IoT device management function module.

In some application scenarios of the present disclosure, the first information may originate from the owner of the IoT terminal, another third party with IoT terminal management authority, or a trusted third party. In this case, the owner of the IoT terminal or the third party may send an instruction or a request for permanently deactivating a certain IoT terminal to a backend support system of an operator via a portal website of the operator. This certain IoT terminal may be associated using an identifier of the IoT terminal, and the IoT device management function in the backend support system of the operator may generate the first information according to the received instruction or request, and send the first information to the policy control function network element.

For the detailed description of steps S210c and S220c, reference may be made to the foregoing embodiments, and details are not described here.

The embodiments of the present application stipulate that various communication system architectures are provided to enable the sending of the first information to the policy control function network element.

FIG. 2d is a flowchart of a communication method according to some embodiments. As shown in FIG. 2d, the communication method may be performed by the policy control function network element, and the communication method includes steps: S210d and S220d.

In step S210d, a policy authorization service invocation request sent by the invoker is received.

In step S220d, the first information is sent.

In some implementations, the policy authorization service invocation request includes the first information.

In some implementations, the first information is configured for the IoT terminal to permanently deactivate the network service.

In some implementations, the invoker may send the policy authorization service invocation request carrying the first information to the policy control function network element, so that the invoker can send the first information to the policy control function network element via the policy authorization service invocation request.

In some implementations, the name of the policy authorization service invocation request is not limited; for example, it may be an Npcf_PolicyAuthorization request or a first service request.

In some implementations, after receiving the policy authorization service invocation request carrying the first information, the policy control function network element may obtain the first information from the policy authorization service invocation request and subsequently send it.

For the detailed description of steps S210d and S220d, reference may be made to the foregoing embodiments, and details are not described here.

The embodiments of the present application stipulate that the policy control function network element may receive the first information via the policy authorization service invocation request sent by the invoker.

FIG. 2e is a flowchart of a communication method according to some embodiments. As shown in FIG. 2e, the communication method may be performed by the policy control function network element, and the communication method includes steps: S210e to S230e.

In step S210e, the policy authorization service invocation request sent by the invoker is received.

In step S220e, a policy authorization service response message is sent to the invoker.

In step S230e, the first information is sent.

In some implementations, the policy authorization service invocation request includes the first information.

In some implementations, the first information is configured for the IoT terminal to permanently deactivate the network service.

In some implementations, the policy authorization service response message is configured for the invoker to determine that a policy authorization service is successfully invoked.

In some implementations, the policy control function network element may respond to a successful policy authorization service invocation request. That is, the policy control function network element may send the policy authorization service response message to the invoker in a case where the policy authorization service invocation request is successfully executed, and the invoker may determine that the policy authorization service invocation is successful according to the policy authorization service response message.

In some implementations, the name of the policy authorization service response message is not limited; for example, it may be an Npcf_PolicyAuthorization response or a first response message.

In some implementations, the policy control function network element may also respond to the invoker in a case where the policy authorization service invocation fails. For example, the policy control function network element may send information indicating that the policy authorization service invocation fails to the invoker.

For the detailed description of steps S210e to S230e, reference may be made to the foregoing embodiments, and details are not described here.

The embodiments of the present application stipulate that the policy control function network element may send the policy authorization service response message to the invoker, to indicate to the invoker that the policy authorization service invocation is successful.

FIG. 2f is a flowchart of a communication method according to some embodiments. As shown in FIG. 2f, the communication method may be performed by a policy control function network element, and the communication method includes steps: S210f and S220f.

In step S210f, subscription data of the IoT terminal is obtained.

In step S220f, the first information is sent, where the subscription data includes second information for allowing the IoT terminal to permanently deactivate the network service.

In some implementations, the first information is configured for the IoT terminal to permanently deactivate the network service.

In some embodiments, the second information is configured to indicate that the IoT terminal is allowed to permanently deactivate the network service.

In some embodiments, the unified data management network element may have subscription data of the IoT terminal, and the subscription data may include a field that records information indicating that the IoT terminal is allowed to permanently deactivate the network service, i.e., a field that records the second information. In this way, the policy control function network element may obtain the subscription data of the IoT terminal from the unified data repository network element. In a case where the subscription data includes the second information for allowing a corresponding IoT terminal to permanently deactivate the network service, it indicates that the corresponding IoT terminal is allowed to permanently deactivate the network service. Therefore, the policy control function network element may send the first information, so that the corresponding IoT terminal may permanently deactivate the network service.

The embodiments of the present application stipulate that the policy control function network element may control the process of whether to send the first information according to whether the subscription data of the IoT terminal includes the second information for allowing the IoT terminal to permanently deactivate the network service, thereby enhancing the management of sending the first information.

FIG. 2g is a flowchart of a communication method according to some embodiments. As shown in FIG. 2g, the communication method may be performed by the policy control function network element, and the communication method includes steps: S210g to S240g.

In step S210g, the policy authorization service invocation request sent by the invoker is received, where the policy authorization service invocation request includes the first information.

In step S220g, the policy authorization service response message is sent to the invoker.

In some implementations, the policy authorization service response message is configured for the invoker to determine that policy authorization service invocation is successful.

In step S230g, the subscription data of the IoT terminal is obtained.

In step S240g, the AM policy control update notification is sent to the access and mobility management function network element, where the AM policy control update notification includes the first information, and the subscription data includes second information for allowing the IoT terminal to permanently deactivate the network service.

In some implementations, the AM policy control update notification is configured for the access and mobility management function network element to send the first information to the IoT terminal.

For the detailed description of steps S210g to S240g, reference may be made to the foregoing embodiments, and details are not described here.

The embodiments of the present application stipulate a communication method between the network device and the IoT terminal, via which the IoT terminal can complete the process of permanently deactivating the network service.

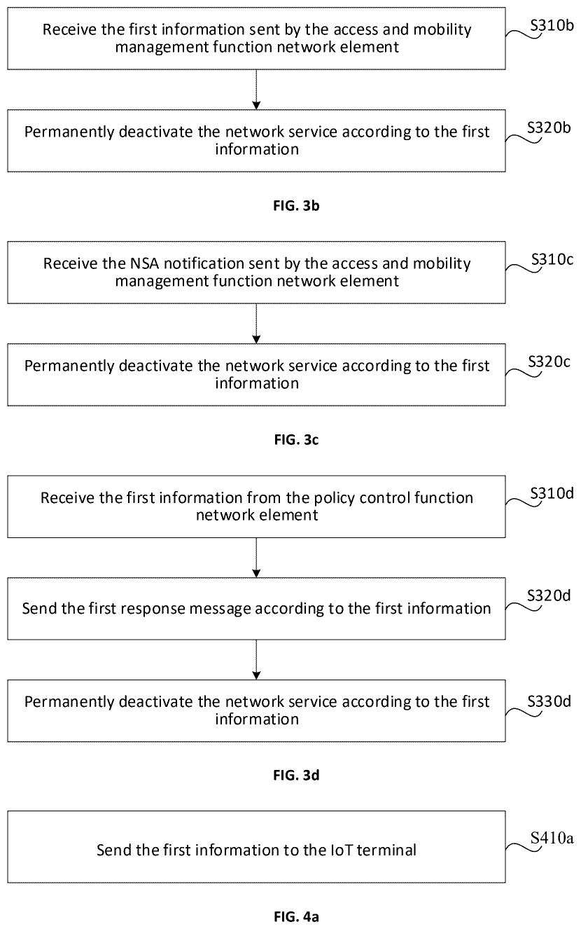

FIG. 3a is a flowchart of a communication method according to some embodiments. As shown in FIG. 3a, the communication method may be performed by the IoT terminal, and the communication method includes steps: S310a and S320a.

In step S310a, the first information from the policy control function network element is received.

In step S320a, the network service is permanently deactivated according to the first information.

In some implementations, the first information may be sent by the policy control function network element, so that the IoT terminal can receive the first information from the policy control function network element.

In some implementations, the first information is sent when the policy control function network element determines that subscription data of the IoT terminal includes the second information for allowing the IoT terminal to permanently deactivate the network service.

In some implementations, the first information is sent by the invoker to the policy control function network element, and the invoker includes at least one of the following:
the extended function of the IoT application function, the new first application function, the new first network element, or the extended function of the policy control function network element.

In some implementations, the first information is sent by the invoker to the policy control function network element via the policy authorization service invocation request.

For the detailed description of steps S310a to S320a, reference may be made to the foregoing embodiments, and details are not described here.

The embodiments of the present application stipulate that the IoT terminal may receive the first information from the policy control function network element, thereby permanently deactivating the network service according to the first information. In this way, the data of the IoT terminal can be prevented from being obtained by an unauthorized user, and the data security of the IoT terminal is protected. A new indication from the policy control function network element to the terminal is provided in the embodiments of the present application.

FIG. 3b is a flowchart of a communication method according to some embodiments. As shown in FIG. 3b, the communication method may be performed by the IoT terminal, and the communication method includes steps: S310b and S320b.

In step S310b, the first information sent by the access and mobility management function network element is received.

In step S320b, the network service is permanently deactivated according to the first information.

In some implementations, the first information is sent by the policy control function network element via the AM policy control update notification to the access and mobility management function network element.

For the detailed description of steps S310b to S320b, reference may be made to the foregoing embodiments, and details are not described here.

The embodiments of the present application stipulate that the policy control function network element may send the first information to the access and mobility management function network element via the AM policy control update notification, so that the terminal can receive the first information sent by the access and mobility management function network element.

FIG. 3c is a flowchart of a communication method according to some embodiments. As shown in FIG. 3c, the communication method may be performed by the IoT terminal, and the communication method includes steps: S310c and S320c.

In step S310c, the NAS notification sent by the access and mobility management function network element is received.

In step S320c, the network service is permanently deactivated according to the first information.

In some implementations, the NAS notification includes the first information.

In some implementations, the name of the NAS notification is not limited; for example, it may be referred to as NAS Notification or a NAS Notification message.

For the detailed description of steps S310c to S320c, reference may be made to the foregoing embodiments, and details are not described here.

The embodiments of the present application stipulate that the access and mobility management function network element may send the NAS notification carrying the first information to the terminal, so that the terminal can receive the first information sent by the access and mobility management function network element via the NAS notification.

FIG. 3d is a flowchart of a communication method according to some embodiments. As shown in FIG. 3d, the communication method may be performed by the IoT terminal, and the communication method includes steps: S310d to S330d.

In step S310d, the first information from the policy control function network element is received.

In step S320d, the first response message is sent according to the first information.

In step S330d, the network service is permanently deactivated according to the first information.

In some implementations, the first response message may be the NAS notification response.

In some implementations, the name of the NAS notification response is not limited; for example, it may be referred to as an NAS Notification response or an NAS Notification response message.

For the detailed description of steps S310d to S330d, reference may be made to the foregoing embodiments, and details are not described here.

The embodiments of the present disclosure stipulate that after receiving the first information, the IoT terminal may respond to the access and mobility management function network element with a response message for the first information.

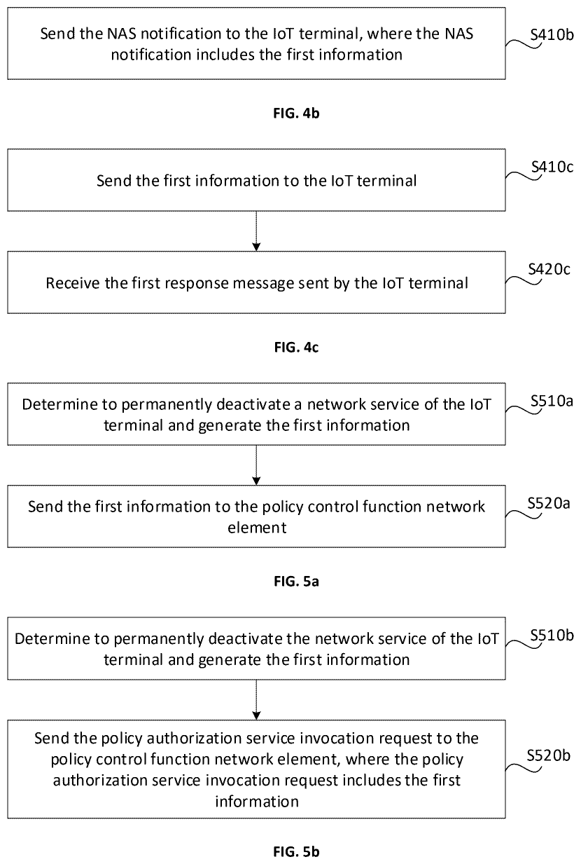

FIG. 4a is a flowchart of a communication method according to some embodiments. As shown in FIG. 4a, the communication method may be performed by the access and mobility management function network element, and the communication method includes step S410a.

In step S410a, the first information is sent to the IoT terminal.

In some implementations, the first information is configured for the IoT terminal to permanently deactivate the network service.

In some implementations, the first information is sent by the policy control function network element to the access and mobility management function network element via the AM policy control update notification.

In some implementations, the first information is sent to the access and mobility management function network element when the policy control function network element determines that the subscription data of the IoT terminal includes the second information for allowing the IoT terminal to permanently deactivate the network service.

In some implementations, the first information is sent by the invoker to the policy control function network element, and the invoker includes at least one of the following:
the extended function of the IoT application function, the new first application function, the new first network element, or the extended function of the policy control function network element.

In some implementations, the first information is sent by the invoker to the policy control function network element via the policy authorization service invocation request.

For the detailed description of step S410a, reference may be made to the foregoing embodiments, and details are not described here.

The embodiments of the present application stipulate that the access and mobility management function network element may send the first information to the IoT terminal, so that the IoT terminal can permanently deactivate the network service according to the first information. In this way, the data of the IoT terminal can be prevented from being obtained by an unauthorized user, and the data security of the IoT terminal is protected. A new indication from the access and mobility management function network element to the terminal is provided in the embodiments of the present application.

FIG. 4b is a flowchart of a communication method according to some embodiments. As shown in FIG. 4b, the communication method may be performed by the access and mobility management function network element, and the communication method includes step S410b.

In step S410b, the NAS notification is sent to the IoT terminal, where the NAS notification includes the first information.

In some implementations, the first information is configured for the IoT terminal to permanently deactivate the network service.

For the detailed description of step S410b, reference may be made to the foregoing embodiments, and details are not described here.

The embodiments of the present disclosure stipulate that the access and mobility management function network element may send the first information to the IoT terminal via the NAS notification, so that the terminal can receive the first information sent by the access and mobility management function network element.

FIG. 4c is a flowchart of a communication method according to some embodiments. As shown in FIG. 4c, the communication method may be performed by the access and mobility management function network element, and the communication method includes steps: S410c and S420c.

In step S410c, the first information is sent to the IoT terminal.

In step S420c, the first response message sent by the IoT terminal is received.

In some implementations, the first response message is sent by the IoT terminal according to the first information.

In some implementations, the first information is configured for the IoT terminal to permanently deactivate the network service.

For the detailed description of steps S410c to S420c, reference may be made to the foregoing embodiments, and details are not described here.

The embodiments of the present disclosure stipulate that after sending the first information to the IoT terminal, the access and mobility management function network element may receive the first response message replied from the IoT terminal.

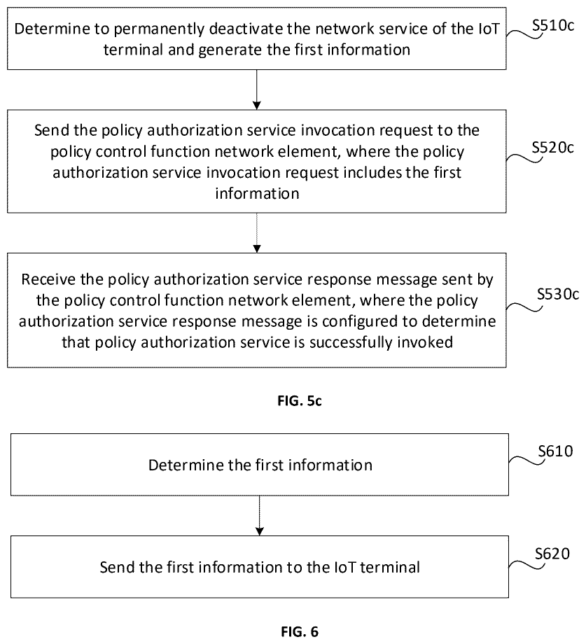

FIG. 5a is a flowchart of a communication method according to some embodiments. As shown in FIG. 5a, the communication method may be performed by the invoker, and the communication method includes steps: S510a and S520a.

In step S510a, it is determined to permanently deactivate a network service of the IoT terminal, and the first information is generated.

In step S520a, the first information is sent to the policy control function network element.

In some implementations, the first information is configured for the IoT terminal to permanently deactivate the network service.

In some implementations, the policy control function network element may send the first information after receiving the first information.

In some implementations, the name of the invoker is not limited and may be, for example, the IoT device management function or the IoT terminal management function mentioned in the foregoing embodiments.

In some implementations, after receiving an instruction or a request for permanently deactivating a certain IoT terminal, which is sent from the owner of the IoT terminal, another third party with the IoT terminal management authority, or the trusted third party, the invoker may determine to permanently deactivate the network service of the IoT terminal and generate the first information.

In some implementations, the invoker is distinct from the policy control function network element. In this case, the invoker includes at least one of the following:
the extended function of the IoT application function, the new first application function, or the new first network element.

In some implementations, the invoker may also be a newly extended function in the policy control function network element, such as a newly extended IoT device management function. In this case, sending, by the invoker, the first information to the policy control function network element may be understood as sending, by the IoT device management function, the first information to other modules in the policy control function network element.

For the detailed description of steps S510a to S520a, reference may be made to the foregoing embodiments, and details are not described here.

The embodiments of the present application stipulate that the first information may be generated and sent to the policy control function network element by the invoker when it is determined to permanently deactivate the network service of the IoT terminal.

FIG. 5b is a flowchart of a communication method according to some embodiments. As shown in FIG. 5b, the communication method may be performed by the invoker, and the communication method includes steps: S510b and S520b.

In step S510b, it is determined to permanently deactivate the network service of the IoT terminal, and the first information is generated.

In step S520b, the policy authorization service invocation request is sent to the policy control function network element, where the policy authorization service invocation request includes the first information.

In some implementations, the first information is configured for the IoT terminal to permanently deactivate the network service.

For the detailed description of steps S510b to S520b, reference may be made to the foregoing embodiments, and details are not described here.

The embodiments of the present disclosure stipulate that the invoker may send the first information to the policy control function network element via the policy authorization service invocation request.

FIG. 5c is a flowchart of a communication method according to some embodiments. As shown in FIG. 5c, the communication method may be performed by the invoker, and the communication method includes steps: S510c to S530c.

In step S510c, it is determined to permanently deactivate the network service of the IoT terminal, and the first information is generated.

In step S520c, the policy authorization service invocation request is sent to the policy control function network element, where the policy authorization service invocation request includes the first information.

In step S530c, the policy authorization service response message sent by the policy control function network element is received, where the policy authorization service response message is configured to determine that the policy authorization service is successfully invoked.

In some implementations, the first information is configured for the IoT terminal to permanently deactivate the network service.

For the detailed description of steps S510c to S530c, reference may be made to the foregoing embodiments, and details are not described here.

The embodiments of the present disclosure stipulate that the invoker may receive the policy authorization service response message sent by the policy control function network element to determine that the policy authorization service is successfully invoked.

FIG. 6 is a flowchart of a communication method according to some embodiments. As shown in FIG. 6, the communication method may be performed by a core network device, and the communication method includes steps: S610 and S620.

In step S610, the first information is determined.

In step S620, the first information is sent to the IoT terminal.

In some implementations, the first information is configured for the IoT terminal to permanently deactivate the network service.

In some implementations, the first information may be determined by the invoker.

In some implementations, the invoker may be independent of a core network device or may be part of the core network device. The core network device determines the first information by receiving the first information sent by the invoker, in a case where the invoker is independent of the core network device. The core network device determines the first information via the included invoker, in a case where the invoker is part of the core network device.

For the detailed description of step S610, reference may be made to the foregoing embodiments, and details are not described here.

The embodiments of the present application stipulate that the core network device may determine the first information and send the first information to the IoT terminal.

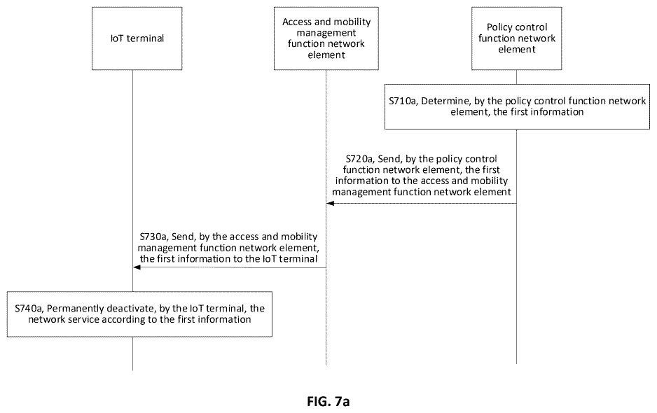

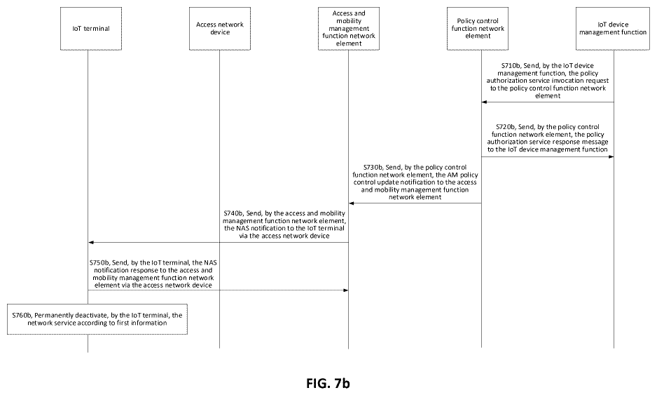

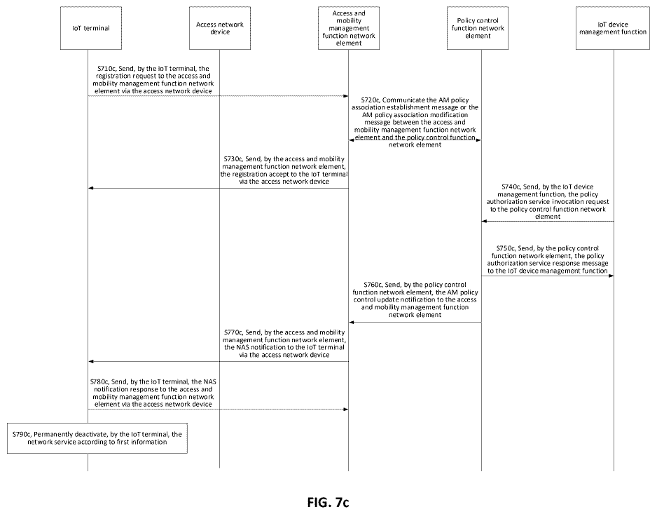

FIG. 7a is a flowchart of a communication method according to some other embodiments. As shown in FIG. 7a, the communication method may be used in a communication system, and the communication system includes the IoT terminal, the policy control function network element, and the access and mobility management function network element. The method includes the following steps: S710a to S740a.

In step S710a, the policy control function network element determines the first information.

In step S720a, the policy control function network element sends the first information to the access and mobility management function network element.

In step S730a, the access and mobility management function network element sends the first information to the IoT terminal.

In step S740a, the IoT terminal permanently deactivates the network service according to the first information.

In some implementations, the first information may be determined by the IoT device management function.

In some implementations, the IoT device management function may be independent of the policy control function network element or may be part of the policy control function network element. The policy control function network element determines the first information by receiving the first information sent by the IoT device management function, in a case where the IoT device management function is independent of the policy control function network element. The policy control function network element determines the first information via the included IoT device management function, in a case where the IoT device management function is part of the policy control function network element.

For the detailed description of steps S710a to S740a, reference may be made to the foregoing embodiments, and details are not described here.

FIG. 7b is a flowchart of a communication method according to some other embodiments. As shown in FIG. 7b, the communication method may be used in a communication system, which includes the IoT terminal 701, the policy control function network element 1032, the access and mobility management function network element 1031, the access network device 102, and the IoT device management function 104. The method includes the following steps: S710b to S760b.

In step S710b, the IoT device management function sends the policy authorization service invocation request to the policy control function network element.

In some implementations, the policy authorization service invocation request includes the first information.

In step S720b, the policy control function network element sends the policy authorization service response message to the IoT device management function.

In some implementations, the policy authorization service response message is configured for the IoT device management function to determine that the policy authorization service is successfully invoked.

In step S730b, the policy control function network element sends the AM policy control update notification to the access and mobility management function network element.

In some implementations, the AM policy control update notification includes the first information.

In step S740b, the access and mobility management function network element sends the NAS notification to the IoT terminal via the access network device.

In some implementations, the NAS notification includes the first information.

In step S750b, the IoT terminal sends the NAS notification response to the access and mobility management function network element via the access network device.

In step S760b, the IoT terminal permanently deactivates the network service according to the first information.

For the detailed description of steps S710b to S760b, reference may be made to the foregoing embodiments, and details are not described here.

FIG. 7c is a flowchart of a communication method according to some other embodiments. As shown in FIG. 7c, the communication method may be used in a communication system, which includes the IoT terminal 701, the policy control function network element 1032, the access and mobility management function network element 1031, the access network device 102, and the IoT device management function 104. The method includes the following steps: S710c to S790c.

In step S710c, the IoT terminal sends the registration request to the access and mobility management function network element via the access network device.

In some implementations, the IoT terminal may send the registration request to the access network device, and the access network device sends the registration request to the access and mobility management function network element via the initial UE message.

In step S720c, the AM policy association establishment message or the AM policy association modification message is communicated between the access and mobility management function network element and the policy control function network element.

In some implementations, in a case where a new AMF selects a new PCF, the new AMF performs AM policy association establishment with the selected PCF.

In a case where a PCF identified by a PCF ID included in the UE context from an old AMF is used, the new AMF performs AM policy association modification with this PCF.

The PCF shall provide updated mobility restrictions to the AMF, in a case where the AMF notifies the PCF of mobility restrictions (such as a UE location) for adjustment, or in a case where the PCF updates the mobility restrictions itself due to some conditions (such as the application in use, time, and date). The AMF provides a tracking requirement to the PCF in a case where subscription information includes the tracking requirement.

In step S730c, the access and mobility management function network element sends the registration accept to the IoT terminal via the access network device.

In step S740c, the IoT device management function sends the policy authorization service invocation request to the policy control function network element.

In some implementations, the policy authorization service invocation request includes the first information.

In step S750c, the policy control function network element sends the policy authorization service response message to the IoT device management function.

In some implementations, the policy authorization service response message is configured for the IoT device management function to determine that the policy authorization service is successfully invoked.

In step S760c, the policy control function network element sends the AM policy control update notification to the access and mobility management function network element.

In some implementations, the AM policy control update notification includes the first information.

In step S770c, the access and mobility management function network element sends the NAS notification to the IoT terminal via the access network device.

In some implementations, the NAS notification includes the first information.

In step S780c, the IoT terminal sends the NAS notification response to the access and mobility management function network element via the access network device.

In step S790c, the IoT terminal permanently deactivates the network service according to the first information.

For the detailed description of steps S710c to S790c, reference may be made to the foregoing embodiments, and details are not described here.

The following is a method for determining a positioning manner in some other embodiments, which includes the following steps: 1 to 8.

In step 1, a UE (an A-IoT device/tag) sends a registration request to an NG-RAN, which includes a registration type, a SUCI, a 5G-GUTI, or a PEI, and a security parameter. The NG-RAN initiates the N2 setup (an initial UE message) to the AMF, where the registration request shall be included in the request from the NG-RAN to the AMF.

In step 2, a new AMF performs AM policy association establishment/modification. In a case where the new AMF selects a new PCF, the new AMF performs AM policy association establishment with the selected PCF.

In a case where a PCF identified by the PCF ID included in the UE context of the old AMF is used, the new AMF performs the AM policy association modification with the PCF.

The PCF shall provide updated mobility restrictions to the AMF, in a case where the AMF notifies the PCF of mobility restrictions (such as a UE location) for adjustment, or in a case where the PCF updates the mobility restrictions itself due to some conditions (such as the application in use, time, and date). The AMF provides the tracking requirement to the PCF in a case where subscription information includes the tracking requirement.

In step 3, the AMF receives the N2 setup request and the registration request. The AMF sends the registration accept to the UE via the NG-RAN, after authentication and authorization of the UE.

In step 4, the IDMF invokes an Npcf_PolicyAuthorization service to the PCF, which includes a “permanent deactivating” indication, in a case where the IDMF determines to permanently deactivate the UE, for example, the owner of the IoT device requests to do that.

In step 5, the PCF responds to the AF (the IDMF) for the successful Npcf_PolicyAuthorization service.

In step 6, the PCF sends Npcf_AMPolicyControl_UpdateNotify to the AMF, which includes an AM policy association ID associated with the SUPI. The policy update may include a service area restriction, UE-AMBR, an RFSP index value, an access stratum time distribution indication, Uu time synchronization error budget, and the “permanent deactivating” indication.

In step 7, the AMF sends the NAS notification to the UE, which includes the “permanent deactivating” indication.

In step 8, when the UE receives the NAS notification, it shall reply to the AMF with a NAS notification response and then permanently deactivate itself, such that the IoT device may never be activated and accessed again.

It is to be noted that a plurality of embodiments or features separated by “or” do not affect other solutions, even though some of the features are not implementable. Additionally, the embodiments of the present disclosure may be combined with other embodiments or implementations related to the communication method and its various optional schemes without contradiction; details are not described here.

An embodiment of the present disclosure further provides an apparatus for performing any one of the aforementioned methods. For example, an apparatus is provided. The above-mentioned apparatus includes units or modules for implementing the steps performed by the terminal in any one of the aforementioned methods. For another example, another apparatus is further provided, including units or modules for implementing the steps performed by the network device in any one of the aforementioned methods.

It is to be understood that the division of various units or modules in each of the above-mentioned apparatuses is merely a logical functional division. In actual implementation, the units or the modules may be fully or partially integrated into one physical entity or physically separated. Additionally, the units or modules in the apparatus may be implemented in the form of a processor invoking software: for example, the apparatus includes a processor, where the processor is connected to a memory, and the memory stores instructions. The processor invokes the instructions stored in the memory to implement any one of the aforementioned methods or to implement the functions of various units or modules in the above-mentioned apparatus. The processor may be a general-purpose processor, such as a central processing unit (CPU) or a microprocessor, and the memory may be a memory inside the apparatus or a memory outside the apparatus. Alternatively, the units or modules in the apparatus may be implemented in the form of hardware circuits, and the functions of part or all of the units or modules may be implemented by designing the hardware circuits. The above-mentioned hardware circuits may be understood as one or more processors. For example, in one implementation, the above-mentioned hardware circuits are application-specific integrated circuits (ASICs), and the functions of part or all of the units or the modules are implemented by designing logical relationships between elements within the circuits. For another example, in another implementation, the above-mentioned hardware circuits may be implemented using programmable logic devices (PLDs), such as field programmable gate arrays (FPGAs), which may include a large number of logic gate circuits. Connection relationships between the logic gate circuits may be configured using configuration files to implement the functions of part or all of the units or modules. All the units or modules of the above-mentioned apparatus may be fully implemented in the form of a processor invoking software, or fully implemented in the form of hardware circuits, or partially implemented in the form of a processor invoking software with the remaining part implemented in the form of hardware circuits.

In the embodiment of the present disclosure, the processor is a circuit capable of processing a signal. In one implementation, the processor may be a circuit with an ability to read and execute instructions, such as a central processing unit (CPU), a microprocessor, a graphics processing unit (GPU) (which may be understood as a microprocessor), or a digital signal processor (DSP). In another implementation, the processor may implement certain functions through the logical relationships of the hardware circuits, where the logical relationships of these circuits are either fixed or reconfigurable. For example, the processor is an application-specific integrated circuit (ASIC) or a hardware circuit implemented by a programmable logic device (PLD), such as an FPGA. In a re-configurable hardware circuit, the process of implementing the hardware circuit configuration by loading a configuration file via the processor may be understood as the process of implementing the functions of part or all of the above-mentioned units or modules by loading instructions via the processor. Additionally, the processor may alternatively be a hardware circuit designed for artificial intelligence, which may be understood as an ASIC, such as a neural network processing unit (NPU), a tensor processing unit (TPU), or a deep learning processing unit (DPU).

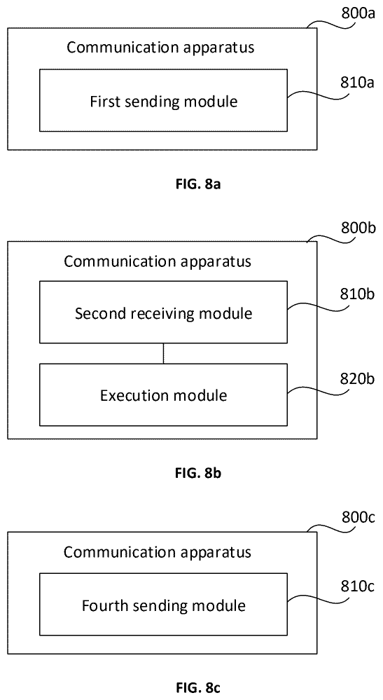

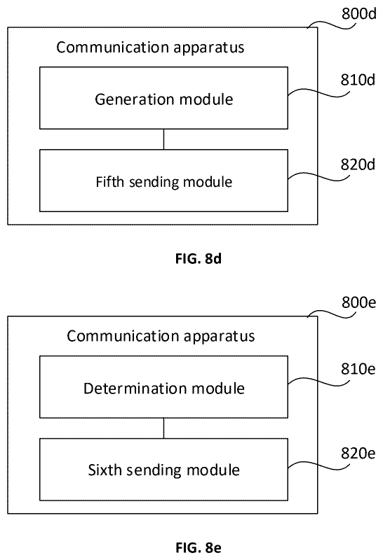

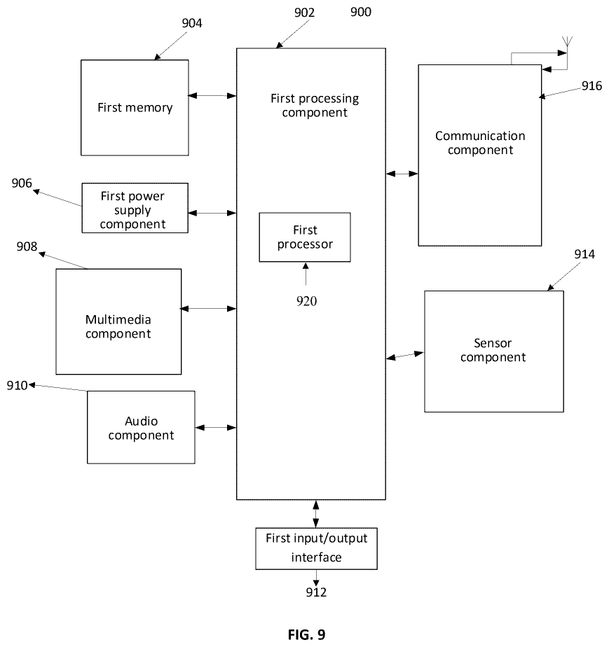

FIG. 8a is a block diagram of a communication apparatus 800a according to some embodiments. Referring to FIG. 8a, the communication apparatus 800a is implemented by a policy control function network element, and the communication apparatus 800a may include:
a first sending module 810a configured to send first information, where the first information is configured for an IoT terminal to permanently deactivate a network service.

In some implementations, the first sending module 810a includes:
a first sending sub-module configured to send an AM policy control update notification to an access and mobility management function network element, where the AM policy control update notification includes the first information, and the AM policy control update notification is configured for the access and mobility management function network element to send the first information to the IoT terminal.

In some implementations, the apparatus 800a further includes:
a first receiving module configured to receive the first information sent by an invoker, where the invoker includes at least one of the following:
an extended function of an IoT application function, a new first application function, a new first network element, or an extended function of the policy control function network element.

In some implementations, the first receiving module includes:
a first receiving sub-module configured to receive a policy authorization service invocation request sent by the invoker, where the policy authorization service invocation request includes the first information.

In some implementations, the apparatus 800a further includes:
a second sending module configured to send a policy authorization service response message to the invoker, where the policy authorization service response message is configured for the invoker to determine that the policy authorization service is successfully invoked.

In some implementations, the first sending module 810a includes:
a first obtaining sub-module configured to obtain subscription data of the IoT terminal; and
a second sending sub-module configured to send the first information, where the subscription data includes second information for allowing the IoT terminal to permanently deactivate the network service.

FIG. 8b is a block diagram of a communication apparatus 800b according to some embodiments. Referring to FIG. 8b, the communication apparatus 800b is implemented by an IoT terminal, and the communication apparatus 800b may include:
a second receiving module 810b configured to receive first information from a policy control function network element; and
an execution module 820b configured to permanently deactivate a network service according to the first information.

In some implementations, the second receiving module 810b includes:
a second receiving sub-module configured to receive the first information sent by an access and mobility management function network element, where the first information is sent, by the policy control function network element via an AM policy control update notification, to the access and mobility management function network element.

In some implementations, the second receiving sub-module includes:
a receiving unit configured to receive an NAS notification sent by the access and mobility management function network element, where the NAS notification includes the first information.

In some implementations, the apparatus 800b further includes:
a third sending module configured to send a first response message to the access and mobility management function network element according to the first information.

In some implementations, the first information is sent in a case where the policy control function network element determines that subscription data of the IoT terminal includes second information for allowing the IoT terminal to permanently deactivate the network service.

In some implementations, the first information is sent by an invoker to the policy control function network element, where the invoker includes at least one of the following:
an extended function of an IoT application function, a new first application function, a new first network element, or an extended function of the policy control function network element.

In some implementations, the first information is sent by the invoker to the policy control function network element via a policy authorization service invocation request.

FIG. 8c is a block diagram of a communication apparatus 800c according to some embodiments. Referring to FIG. 8c, the communication apparatus 800c is implemented by an access and mobility management function network element, and the communication apparatus 800c may include:
a fourth sending module 810c configured to send first information to an IoT terminal, where the first information is configured for the IoT terminal to permanently deactivate a network service.

In some implementations, the fourth sending module 810c includes:
a third sending sub-module configured to send an NAS notification to the IoT terminal, where the NAS notification includes the first information.

In some implementations, the apparatus 800c further includes:
a third receiving module configured to receive a first response message sent by the IoT terminal, where the first response message is sent by the IoT terminal according to the first information.

In some implementations, the first information is sent by a policy control function network element via an AM policy control update notification to the access and mobility management function network element.

In some implementations, the first information is sent to the access and mobility management function network element in a case where the policy control function network element determines that subscription data of the IoT terminal includes second information for allowing the IoT terminal to permanently deactivate the network service.

In some implementations, the first information is sent by an invoker to the policy control function network element, where the invoker includes at least one of the following:
an extended function of an IoT application function, a new first application function, a new first network element, or an extended function of the policy control function network element.

In some implementations, the first information is sent by the invoker to the policy control function network element via a policy authorization service invocation request.

FIG. 8d is a block diagram of a communication apparatus 800d according to some embodiments. Referring to FIG. 8d, the communication apparatus 800d is implemented by an invoker, and the communication apparatus 800d may include:
a generation module 810d configured to determine to permanently deactivate a network service of an IoT terminal and generate first information; and
a fifth sending module 820d configured to send the first information to a policy control function network element, where the first information is configured for the IoT terminal to permanently deactivate the network service.

In some implementations, the fifth sending module 820d includes:
a fourth sending sub-module configured to send a policy authorization service invocation request to the policy control function network element, where the policy authorization service invocation request includes the first information.

In some implementations, the apparatus 800d further includes:
a fourth receiving module configured to receive a policy authorization service response message sent by the policy control function network element, where the policy authorization service response message is configured to determine that the policy authorization service is successfully invoked.

In some implementations, the invoker includes at least one of the following:
an extended function of an IoT application function, a new first application function, or a new first network element.

FIG. 8e is a block diagram of a communication apparatus 800e according to some embodiments. Referring to FIG. 8e, the communication apparatus 800e is implemented by a core network device, and the communication apparatus 800e may include:
a determination module 810e configured to determine first information; and
a sixth sending module 820e configured to send the first information to an IoT terminal, where the first information is configured for the IoT terminal to permanently deactivate a network service.

For the apparatus in the above-mentioned embodiments, the specific manner in which each module performs operations has been described in detail in the embodiments related to the method, and is not elaborated here.

The present disclosure further provides a non-transitory computer-readable storage medium storing computer program instructions, where the program instructions, when executed by a processor, perform the steps of the communication methods provided by the present disclosure.

FIG. 9 is a block diagram of a terminal according to some embodiments. For example, the terminal 900 may be an IoT terminal.

Referring to FIG. 9, the terminal 900 may include one or more of the following components: a first processing component 902, a first memory 904, a first power supply component 906, a multimedia component 908, an audio component 910, a first input/output interface 912, a sensor component 914, and a communication component 916.

The first processing component 902 generally controls the overall operation of the terminal 900, such as operations associated with display, phone calls, data communication, camera operations, and recording operations. The first processing component 902 may include one or more first processors 920 to execute instructions to complete all or part of the steps of the above-mentioned communication methods. Additionally, the first processing component 902 may include one or more modules to facilitate interaction between the first processing component 902 and another component. For example, the first processing component 902 may include a multimedia module to facilitate interaction between the multimedia component 908 and the first processing component 902.

As used herein, the term processor may refer to one processor that performs the defined functions or a plurality of processors that collectively perform defined functions, such that the execution of the individual defined functions may be divided amongst such processors.

The first memory 904 is configured to store various types of data to support an operation on the terminal 900. Examples of such data include instructions for any applications or methods operating on terminal 900, contact data, phonebook data, messages, pictures, videos, and so on. The first memory 904 may be implemented by any type of volatile or non-volatile storage devices or their combinations, such as a static random access memory (SRAM), an electrically erasable programmable read-only memory (EEPROM), an erasable programmable read-only memory (EPROM), a programmable read-only memory (PROM), a read-only memory (ROM), a magnetic storage, a flash memory, a magnetic disk, or an optical disc.

The first power supply component 906 supplies power to various components of the terminal 900. The first power supply component 906 is powered by an energy harvesting apparatus or activator, and may include a component associated with power generation, management, and distribution for the terminal 900.

The multimedia component 908 includes a screen providing an output interface between the terminal 900 and a user. In some embodiments, the screen may include a liquid crystal display (LCD) and a touch panel (TP). In a case where the screen includes the touch panel, the screen may be implemented as a touchscreen to receive an input signal from the user. The touch panel includes one or more touch sensors to sense touch, slide, and gestures on the touch panel. The touch sensors may not only sense boundaries of a touch or slide action, but also detect duration and pressure associated with the touch or slide operation. In some embodiments, the multimedia component 908 includes a front camera and/or a rear camera. The front camera and/or the rear camera may receive external multimedia data, in a case where the terminal 900 is in an operating mode, such as a shooting mode or a video mode. Each of the front camera and the rear camera may be one fixed optical lens system or have a focal length and an optical zoom capability.

The audio component 910 is configured to output and/or input an audio signal. For example, the audio component 910 includes one microphone (MIC). The microphone is configured to receive an external audio signal in a case where the terminal 900 is in the operating mode, such as a call mode, a recording mode, or a voice recognition mode. The received audio signal may be further stored in the first memory 904 or sent via the communication component 916. In some embodiments, the audio component 910 further includes one speaker configured to output the audio signal.

The first input/output interface 912 provides an interface between the first processing component 902 and a peripheral interface module. The above-mentioned peripheral interface module may be a keyboard, a click wheel, buttons, etc. These buttons may include, but are not limited to, a home button, volume buttons, a power button, and a lock button.

The sensor component 914 includes one or more sensors for providing status assessments on various aspects of the terminal 900. For example, the sensor component 914 may detect an on/off state of the terminal 900 and the relative positioning of components. For example, the components are a display and a keypad of the terminal 900. The sensor component 914 may further detect changes in the position of the terminal 900 or one component of the terminal 900, whether the user is in contact with the terminal 900, an orientation or acceleration/deceleration of the terminal 900, and temperature changes of the terminal 900. The sensor component 914 may include a proximity sensor configured to detect the presence of a nearby object without physical contact. The sensor component 914 may further include a light sensor, such as a complementary metal-oxide-semiconductor (CMOS) or charge-coupled device (CCD) image sensor, for use in imaging applications. In some embodiments, the sensor component 914 may further include an acceleration sensor, a gyroscope sensor, a magnetic sensor, a pressure sensor, or a temperature sensor.

The communication component 916 is configured to facilitate communication between the terminal 900 and another device in a wired or wireless manner. The terminal 900 may access a wireless network based on a communication standard such as Wi-Fi, 2G, or 3G, or their combinations. In one example, the communication component 916 receives a broadcast signal or broadcast-related information from an external broadcast management system via a broadcast channel. In one example, the communication component 916 further includes a near field communication (NFC) module to facilitate short-range communication. For example, the NFC module may be implemented based on radio frequency identification (RFID) technology, infrared data association (IrDA) technology, ultra-wideband (UWB) technology, Bluetooth (BT) technology, and other technologies.

In an example, the terminal 900 may be implemented by one or more application-specific integrated circuits (ASICs), digital signal processors (DSPs), digital signal processing devices (DSPDs), programmable logic devices (PLDs), field-programmable gate arrays (FPGAs), controllers, microcontrollers, microprocessors, or other electronic components to perform the above-mentioned communication methods.

For example, a non-transitory computer-readable storage medium, including instructions, is further provided, such as the first memory 904, which contains these instructions. The above-mentioned instructions may be executed by the first processor 920 of the terminal 900 to complete the above-mentioned communication methods. For example, the non-transitory computer-readable storage medium may be a read-only memory (ROM), a random access memory (RAM), a compact disc read-only memory (CD-ROM), a magnetic tape, a floppy disk, an optical data storage device, etc.

The above-mentioned apparatus may be an independent electronic device or may be part of an independent electronic device. For example, in one embodiment, the apparatus may be an integrated circuit (IC) or a chip, where the integrated circuit may be a single IC or a set of multiple ICs. The chip may include, but is not limited to, the following types: a graphics processing unit (GPU), a central processing unit (CPU), a field programmable gate array (FPGA), a digital signal processor (DSP), an application-specific integrated circuit (ASIC), a system on chip (SoC), etc. The aforementioned integrated circuit or chip may be configured to execute executable instructions (or code) to implement the above-mentioned communication methods. Executable instructions may be stored in an integrated circuit or chip or may be obtained from another apparatus or device. For example, the integrated circuit or chip includes a processor, memory, and an interface for communicating with other apparatuses. The executable instructions may be stored in the memory, and when executed by the processor, they implement the above-mentioned communication methods. Alternatively, the integrated circuit or chip may receive executable instructions via the interface and transmit them to the processor to execute, thereby implementing the above-mentioned communication methods.

In another example, a computer program product is further provided, including a computer program that can be executed by a programmable apparatus. The computer program has a code portion for implementing the above-mentioned communication methods when executed by the programmable apparatus.

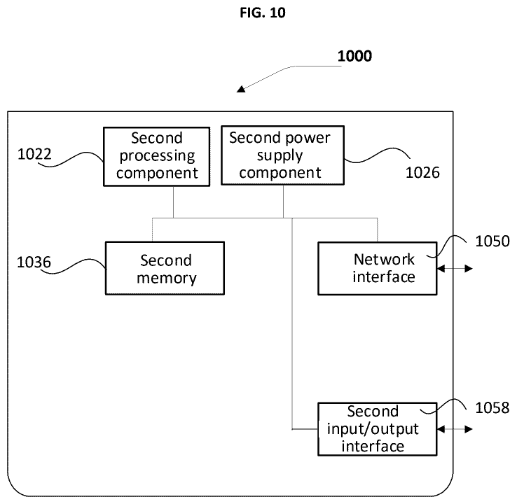

FIG. 10 is a block diagram of a network device according to an example. For example, the network device 1000 may be provided as a core network device, an access network device, or another network logical entity in an AF. Referring to FIG. 10, the network device 1000 includes a second processing component 1022, which further includes one or more processors; and a memory resource represented by a second memory 1036, for storing instructions executable by the second processing component 1022, such as applications. The applications stored in the second memory 1036 may include one or more modules, each corresponding to a set of instructions. Additionally, the second processing component 1022 is configured to execute instructions to perform the steps of the communication methods provided by the above-mentioned method embodiments.

The network device 1000 may further include a second power component 1026 configured to perform power management for the network device 1000, a wired or wireless network interface 1050 for connecting the network device 1000 to a network, and a second input/output interface 1058. The network device 1000 may operate based on an operating system stored in the second memory 1036, such as Windows Server™, Mac OS X™, Unix™, Linux™, FreeBSD™, or similar.

The embodiments of the present disclosure are not exhaustive and are merely illustrative of some embodiments, without imposing specific limitations on the scope of protection of the present disclosure. Each step in a certain embodiment may be implemented as an independent embodiment, and various steps may be arbitrarily combined without conflict. For example, a solution in which some steps are removed from a certain embodiment may also be implemented as an independent embodiment, and the order of various steps in a certain embodiment may be exchanged arbitrarily. Additionally, optional implementations of a certain embodiment may be arbitrarily combined. Furthermore, various embodiments may be arbitrarily combined. For example, some or all steps of different embodiments may be arbitrarily combined, or a certain embodiment may be arbitrarily combined with optional implementations of other embodiments. In various embodiments of the present disclosure, the terms and/or descriptions across various embodiments are consistent. They can be referenced interchangeably in cases where there is no specific explanation or logical conflict. The technical features in different embodiments may be combined based on their inherent logical relationships to form new embodiments.

Those skilled in the art readily think of other implementations of the present disclosure after considering the specification and practicing the present disclosure. The present application is intended to cover any variations, uses, or adaptations of the present disclosure. These variations, uses, or adaptations follow the general principles of the present disclosure and include common knowledge or conventional technical means in the technical field that are not disclosed in the present disclosure. The specification and the embodiments are to be considered as illustrative merely, and the true scope and spirit of the present disclosure are indicated by the following claims.

It is to be understood that the present disclosure is not limited to the precise structure described above and shown in the drawings, and various modifications and changes may be made without departing from its scope. The scope of the present disclosure is limited merely by the appended claims.

1. A communication method, performed by a policy control function network element, comprising:
sending first information, wherein the first information is configured for an Internet of Things (IoT) terminal to permanently deactivate a network service.

2. The method according to claim 1, wherein sending the first information comprises:
sending an access management (AM) policy control update notification to an access and mobility management function network element, wherein the AM policy control update notification comprises the first information, and the AM policy control update notification is configured for the access and mobility management function network element to send the first information to the IoT terminal.

3. The method according to claim 1, further comprising:
receiving the first information sent by an invoker, wherein the invoker comprises at least one of the following:
an extended function of an IoT application function, a new first application function, a new first network element, or an extended function of the policy control function network element.

4. The method according to claim 3, wherein receiving the first information sent by the invoker comprises:
receiving a policy authorization service invocation request sent by the invoker, wherein the policy authorization service invocation request comprises the first information.

5. The method according to claim 4, further comprising:
sending a policy authorization service response message to the invoker, wherein the policy authorization service response message is configured for the invoker to determine that a policy authorization service is successfully invoked.

6. The method according to claim 1, wherein sending the first information comprises:
obtaining subscription data of the IoT terminal; and
sending the first information, wherein the subscription data comprises second information for allowing the IoT terminal to permanently deactivate the network service.

7. A communication method, performed by an Internet of Things (IoT) terminal, comprising:
receiving first information from a policy control function network element; and
permanently deactivating a network service according to the first information.

8. The method according to claim 7, wherein receiving the first information from the policy control function network element comprises:
receiving the first information sent by an access and mobility management function network element, wherein the first information is sent, by the policy control function network element via an access management (AM) policy control update notification, to the access and mobility management function network element.

9. The method according to claim 8, wherein receiving the first information sent by the access and mobility management function network element comprises:
receiving a non-access stratum (NAS) notification sent by the access and mobility management function network element, wherein the NAS notification comprises the first information.

10. The method according to claim 8, further comprising:
sending a first response message to the access and mobility management function network element according to the first information.

11. The method according to claim 7, wherein the first information is sent in a case where the policy control function network element determines that subscription data of the IoT terminal comprises second information for allowing the IoT terminal to permanently deactivate the network service; or
the first information is sent by an invoker to the policy control function network element, and the invoker comprises at least one of the following:
an extended function of an IoT application function, a new first application function, a new first network element, or an extended function of the policy control function network element.

12. (canceled)

13. The method according to claim 11, wherein the first information is sent by the invoker to the policy control function network element via a policy authorization service invocation request.

14. A communication method, performed by an access and mobility management function network element, comprising:
sending first information to an Internet of Things (IoT) terminal, wherein the first information is configured for the IoT terminal to permanently deactivate a network service.

15. The method according to claim 14, sending the first information to the IoT terminal comprises:
sending a non-access stratum (NAS) notification to the IoT terminal, wherein the NAS notification comprises the first information.

16. The method according to claim 14, further comprising:
receiving a first response message sent by the IoT terminal, wherein the first response message is sent by the IoT terminal according to the first information.

17. The method according to claim 14, wherein the first information is sent, by a policy control function network element via an access management (AM) policy control update notification, to the access and mobility management function network element; or
the first information is sent to the access and mobility management function network element in a case where the policy control function network element determines that subscription data of the IoT terminal comprises second information for allowing the IoT terminal to permanently deactivate the network service.

18. (canceled)

19. The method according to claim 17, the first information is sent by an invoker to the policy control function network element, and the invoker comprises at least one of the following:
an extended function of an IoT application function, a new first application function, a new first network element, or an extended function of the policy control function network element.

20. The method according to claim 19, wherein the first information is sent by an invoker to the policy control function network element via a policy authorization service invocation request.

21-31. (canceled)

32. A communication device, comprising:
one or more processors; and
a memory that stores computer-executable instructions;
wherein the computer-executable instructions, when collectively executed by the one or more processors,
cause the communication device to perform the communication method according to claim 7.

33. (canceled)

34. A non-transitory computer-readable storage medium storing computer-executable instructions, wherein the computer-executable instructions, when executed by a communication device, cause the communication device to perform the communication method according to claim .
